(19) United States
(12) Patent Application Publication
(10) Pub. No.: US 2017/0154691 A1
(43) Pub. Date: Jun. 1, 2017

(54) Post-meltdown nuclear power plant recovery system

(71) Applicant: Harold James Willard, JR., Washington, DC (US)

(72) Inventor: Harold James Willard, JR., Washington, DC (US)

(21) Appl. No.: 14/757,178

(22) Filed: Dec. 1, 2015

(51) Int. Cl. G21C 15/18; G21C 1/08

(52) U.S. Cl. CPC G21C 15/18; G21C 1/086

(57) ABSTRACT

A system is created to minimize damage to personnel and the environment following melt-down of the core of a pressurized water nuclear power plant (PWR) by removing heat from the melted core using solid state carbon dioxide (dry ice) rather than water in order to reduce the risk of inducing criticality in the subcritical assembly which could occur with the addition of water, a moderator, or the risk of an explosion due to the addition of hydrogen produced in the radiolysis of water or in the zirconium-water corrosion reaction; the system uses dry ice pellets manufactured at the site as part of the existing Emergency Core Cooling System (ECCS), or incorporated into the designs of new plants; carbon dioxide also acts as a fire suppressant.

### (a) CROSS-REFERENCE TO RELATED APPLICATIONS

Provisional Appl. 62/176,573; filed Feb. 23, 2015; Conf. 2833

### (b) STATEMENT REGARDING FEDERALLY SPONSORED RESEARCH OR DEVELOPMENT

Not applicable.

### (c) THE NAMES OF PARTIES TO A JOINT RESEARCH AGREEMENT

Not applicable.

### (d) REFERENCE TO AN APPENDIX ON A COMPACT DISK

Not applicable.

### (e) REFERENCES CITED

(1) Fuller, John G., We Almost Lost Detroit, Ballantine Books, New York, 1975.
(2) Walker, J. Samuel, Three Mile Island, University of California Press, Berkeley, 2004.
(3) Cheney, G. A., Chernobyl, The Ongoing Story of the World's Deadliest Nuclear Disaster, New Discovery Books, New Yorks, 1993.
(4) “Plugging Reactor Leaks: Specifically Designed Robots Examine and Repair Fukushima Daiichi Unit 2”; Mechanical Engineering, No. 02/137, February 2015, p. 10.
(5) Gofman, J. W., Ph.D, M.D. and Tampler, A. R., Ph.D., Poisoned Power, The Case Against Nuclear Power Before and After Three Mile Island, Rodale Press, Emanus, P A, 1979.
(6) Glasstone, S. and Sesonske, A., Nuclear Reactor Engineering Reactor Design Basics, 4th Ed., Vol. I, Springer, 1994.
(7) Willard, H. J., Jr., “Irradiation Growth of Zircaloy”, Sixth International Conference on Zirconium in the Nuclear Industry, ASTM STP 824, 452-480.
(8) Skupinski, E., Tolley, B. and Vilain, J., Safety of Thermal Reactors, Graham & Trotman Limited, London, 1985.

### (f) U.S. PATENTS CITED

| | | | |
|---|---|---|---|
| 5,057,271 | October 1991 | Turricchia | 376/280 |
| 5,295,170 | March 1994 | Schulz | 376/309 |
| 5,309,489 | May 1994 | Tate, et al | 376/283 |
| 6,209,341 B1 | April 2001 | Benedetti, et al | 62/388 |
| 6,240,743 B1 | May 2001 | Allen | 62/605 |
| 8,976,920 B2 | March 2015 | Pop, et al | 376/305 |

### (1) BACKGROUND OF THE INVENTION

(1.1) There are over one hundred commercial nuclear power plants in the USA and over five hundred worldwide, with more under construction, whose primary purpose is to produce electrical power. Each of these plants has sufficient radioactive material within its operating core or in swimming pool storage areas adjacent to the plants to render a major metropolitan area uninhabitable for hundreds of years, if a major event at the facility should occur (1), such as a terrorist attack, sabotage, operator error, etc.

(1.2) Three serious nuclear power plant events have already occurred: Three Mile Island in Pennsylvania, USA (1979); Chernobyl in Ukraine (1986); and Kukushima Daiichi in Japan (2003)(2,3,4). In each case, the Emergency Core Cooling System (ECCS) designed to prevent excessive temperatures from being reached in the fuel elements failed to function as intended, allowing the cores to melt and molten metal to fall to the bottom of their pressure vessels. Release of unacceptably large amounts of radioactivity occurred in all three, with thirty-one deaths at Chernobyl and long-term somatic and genetic effects in exposed populations yet to be determined for all three events.

(1.3) FIG. 1 is a schematic of a pressurized water reactor (PWR) nuclear power plant, typically of 1000 MWe power output, operating at 3000 MW thermal power. FIG. 2 is a schematic of the ECCS for the plant of FIG. 1, not shown in FIG. 1 for clarity. Plans are underway to construct much smaller plants to reduce the radioactive inventory in each plant; however, the total amount of radioactive material will increase since the smaller plants do not have the benefit of economy of size, although monetary savings can be achieved since mass production methods for manufacturing these plants can be used. FIG. 3 is a schematic of the Emergency Core Cooling System and reactor located within its containment vessel, a reenforced concrete structure which may be 30 meters in diameter and 60 meters high. This facility is located above ground, typical of commercial plants in the USA, in spite of the recommendation of Edward Teller, known as “Father of the hydrogen bomb” and a founder of the nuclear industry, that such plants be located under ground for the protection of the public and environment (5).

(1.4) In FIG. 1, [1] is a steel pressure vessel, whose wall may be 15 cm thick, with penetrations for one or more coolant loops, such as the one shown. Steel of this thickness exhibits radiation hardening as a result of exposure to neutron radiation from the core [2] such that the vessel becomes brittle below a certain critical temperature, exhibiting glass-like behavior when subjected to stress. Above this critical temperature, it is far more ductile. However, when such steel is subjected to prolonged irradiation from years of exposure, the transition temperature may become greater than room temperature, requiring very carefully defined procedures to heat up or cool down the vessel in order to avoid excessive stresses caused by differential thermal strains. A major event, such as a meltdown, could cause excessively large stresses in the pressure vessel, with the possibility of brittle fracture and release of radioactivity from the nuclear core. Efforts are underway to increase the lifetimes of nuclear plants from 20 years to 60 years to reduce operating costs using the same vessels.

(1.5) In FIG. 1, [2] is the reactor core, the source of power from nuclear fission reactions. The reactor has about 200 assemblies of fuel and control elements, each assembly having about 264 individual rods (6), 9.5 mm O.D., 4 M long, with a total inventory of uranium dioxide of about 115,000 KG, with 3% enrichment of U235. The primary coolant system operates at 15.5 MPa (2200 psia), at about 300° C. [3] are control rods, typically made of a neutron absorbing metal, such as hafnium or cadmium, which determine the level of power produced in the core and the rate at which that level can be changed. The core can produce power at a one watt level or a 3000 MW level, determined by the position of the control rods. If withdrawn too fast, or too far, a runaway power excursion can occur. There are two major types of water cooled plants: pressurized water and boiling water. In a boiling water plant (BWR), the coolant is allowed to boil inside the reactor vessel in order to produce steam. In a PWR, the pressure is kept sufficiently high to prevent boiling. The coolant (water) is an essential part of the nuclear reaction, hydrogen in the water molecule serving as a moderator to slow down neutrons produced in the fission events in order for them to be able to continue the reaction. If the water is removed, the fission reaction shuts down, offering an inherent stability to this reactor design. However, this inherent safety feature is insufficient to remove other inherent dangers in the operation of these plants.

(1.6) If a plant has been operated for some time, it will retain heat even after shut down, just as a pot on a stove remains hot after the heat is removed. This latent heat in a nuclear power plant, however, is sufficient to melt the fuel elements if not removed by continuing the flow of coolant. Additionally, the nuclear reaction does not completely shut down when the criticality reaction ceases. About 7% of the operating power continues to be produced due to “decay heat” produced from secondary nuclear reactions, which must also be removed by flow of coolant through the core to prevent meltdown. Consequently, if a plant emergency should occur resulting is a loss of coolant or loss of coolant flow or loss of pressure, the core may be shut down by inserting control rods, but a backup means must be provided for removing the heat still in the core. Such systems are called “Emergency Core Cooling Systems (ECCS)”.

(1.7) In a PWR, heat produced in the core raises the temperature of the coolant, which is at high pressure to prevent flashing to steam. This pressure is controlled by a partially filled pressurizer [5] using heaters and quenchers. Reactor coolant pumps [6] circulate the coolant through the primary loop, which includes a steam generator [7] in which water at much lower pressure is allowed to flash to steam in the secondary side to turn turbine blades [8] in order to turn a generator [9] to produce electrical power. It is far more effective to pump water than steam, therefore steam exiting from the turbine is converted to water in the condenser [10] and then returned to the steam generator via pump [11], closing the loop. Two loops are required because water flowing through the reactor becomes radioactive, a hazard to personnel. The primary loop is shielded from the secondary loop for this reason.

(1.8) In the Three Mile Island event, a secondary side feedwater pump [11] tripped off the line, removing the ability of the secondary loop to remove heat from the primary loop. An auxiliary pump in parallel with the main feedwater pump should have immediately started and picked up the flow, however, a valve was left closed shutting off the flow, even though by law (regulation) this valve was required to be open at any time the reactor was critical and should have been observed during routine inspections by plant management and engineers. Overheating of the primary loop coolant occurred, resulting in increased pressure, which caused a relief valve [12] on the pressurizer [5] to release coolant; however, this valve remained stuck in the open position, allowing primary coolant to flash to steam and the core to boil dry, resulting in fuel element failure. This plant remains closed due to radioactive contamination.

(1.9) At Chernobyl, a 1000 ton concrete disk ten feet thick covering the reactor was tossed about due to the explosion when supercriticality was reached due to operator error (3). A city of 42,000 remains abandoned for the next 500 years due to radioactivity.

(1.10) A terrorist or sabotage attack would not have to reach the core of a nuclear plant if the explosion due to a bomb, missile or airplane were sufficient to rupture the pressure vessel since this could expose the core and the safety of a large metropolitan area.

(1.11) The system of FIG. 1 has many devices to monitor fluid flow, pressure, temperature and nuclear characteristics in order that the operator can place the plant in a safe condition in the event of a pump, turbine or steam generator malfunction, or a small leak in a pipe resulting in a core shutdown (SCRAM). The ECCS exists to remove latent and decay heat in the event of a major leak or depressurization to prevent melting of the core. The ECCS is complex, as shown in FIG. 2, with various pumps, etc. coming into play depending upon the pressure existing when the breach occurred.

(1.12) If nuclear power plants are operated at higher core temperatures, they may achieve higher thermodynamic efficiency and therefore greater profitability. Similarly, if a plant increases the time between refuelings, its operating costs may be reduced, resulting in greater profits. However, there is danger in both options because of a phenomenon called “irradiation growth”. Uranium is a very strong, heavy metal and it was once believed that it might be suitable to make fuel rods directly from pure uranium. However, early tests revealed a bar of uranium subjected to irradiation increased its length by a factor of two, while decreasing its cross-sectional area. Its atoms, knocked about by the radiation do not return to their original positions, exhibiting “irradiation growth”. To get around this problem, uranium was put into an oxide form, pellet size, and loaded into fuel rods.

(1.13) Irradiation growth is also observed in other anisotropic metals, including zirconium, the metal used in Zircaloy, used in the rods in commercial nuclear power plants, but to a much less extent than in uranium. FIG. 3 illustrates growth of Zircaloy. In early studies, it was found that growth strain of Zircaloy was relatively small and appeared to saturate. Therefore the strain curve was extrapolated to predict the strain at longer times. Later studies (7), however, revealed that after sufficiently long periods, the strain increases and does not saturate. Furthermore, at higher temperature, the breakaway occurs earlier, leading to greater increases in the lengths of the rods. If commercial cores are operated for longer periods or at higher temperatures to increase profitability without allowing for this behavior, fuel rod bowing can occur with subsequent fuel element failure.

(1.14) The inventor has alerted the Institute for Nuclear Power Operations (INPO) of his concerns since this issue is not addressed in any of the references available to him. It renders use of a post-meltdown recovery system of primary concern. since, in addition to a terrorist event, sabotage, operational error or manufacturing defect, it identifies a possible design weakness as a means for a core melt-down to occur.

(1.15) Safety features for a PWR are intended to satisfy four criteria: 1. to supply water to the core in the event of a loss-of-coolant event (ECCS); 2. to present a barrier via the containment vessel to the escape of radioactivity to the environment; 3. to provide a means to remove radioactivity and heat which may be present in the atmosphere of the containment facility; and 4. to prevent hydrogen build-up from reaching an explosive level of 8%(6). Hydrogen may be produced through the radiolysis of water or through the corrosion of zirconium in a radiation environment.

(1.16) The ECCS of FIG. 2 allows for three leak conditions: a small leak such as might exist from a small pipe or stuck relief valve yielding; a slight decrease in system pressure; a medium leak giving rise to a larger drop in primary loop pressure; and a large leak for which the system pressure drops precipitously. The ECCS requires electrical power to operate pumps [12], [13], and [14] to circulate borated water through the hot leg from the refueling water storage tank [15]. Water is also available from the containment sump [16]. Heat is removed from the hot leg via heat exchanger [17], which also removes radioactivity. Concentrated boric acid [18] can be pumped into the cold leg, which also has a passive backup system using an accumulator tank [19] with borated water under nitrogen pressure [20]

(1.17) After a major breech of the reactor coolant system of a PWR plant, such as happened at TMI and Fukushima, the ECCS will likely be inadequate to remove both latent and decay heat, assuming that a core shutdown was successful to prevent a runaway supercritical condition. A core meltdown is likely and a system must be available to remove both latent and decay heat from the melted assembly of fuel elements without exacerbating the situation. Adding water to the melted assembly could support hydrogen formation which could be dangerous even if the overall concentration does not exceed eight percent, necessary for a spontaneous explosion. If the hydrogen concentration should exceed 8% in a localized area, an explosion at that location is conceivable, which could then spread to areas having hydrogen concentrations of lower values.

(1.18) Furthermore, if for any reason water without the addition of boron were to be used to cool down the melted blob, it could supply the necessary hydrogen to act as a moderator to bring the mass to a critical configuration, leading to a nuclear event. It is conceivable that the explosion at Fukushima was due to this cause. Again, once a core meltdown has occurred, it is prudent to avoid using water to remove heat from the damaged assembly. The present invention proposes using solid state carbon dioxide (dry ice) for this purpose.

(1.19) FIG. 3 shows an advanced nuclear power plant design to resolve concerns about plant size and ECCS (6). These plants, About ⅓ the size of large plants (i.e 600 MWe vs 2100 MWe), use ECCS passive systems which are self-contained or self-supported and are powered by gravity or stored energy (such as compressed gasses). They are expected to operate for up to 72 hours after the initiating event, independent of operator action and off-site power. Decay and latent heat are removed using heat exchanger [16] in the refueling water storage tank [17] located within the containment [18]. It is not clear as to what the consequences are of removing cooling and radioactive shielding water from spent fuel rods stored in the tank.

(1.20) For small leaks, a core makeup tank [19] containing borated water injects water into the system by gravity through a pressure controlled valve via an accumulator [20], pressurized with nitrogen. This system eliminates the need for pumps and diesel generators. Furthermore, the containment vessel is designed for passive cooling, with an inner steel shell [21] which transfers heat to the outer area by natural convection, and by water in a storage tank [22] at the top of the containment, which allows water to evaporate on the outside of the shell to ensure that pressure within the containment does not become excessive. These plants are designed for 60 year operating lives, using mass production methods to reduce unit costs.

(1.21) Disposal of radioactive waste, following reprocessing of the fuel to recover useful isotopes, remains a problem still in contention since the facility at Yucca Flats is the subject of controversy. Therefore, large amounts of spent fuel remain in swimming pools adjacent to their power plants, more vulnerable to terrorist attacks than the fuel within the plants, apparently.

(1.22) Variations on the ECCS previously discussed are presented in the Proceedings of a seminar, “Safety of Thermal Water Reactors”, held in Brussels 1984. These, using water, suffer from the same deficiencies discussed above (8).

(1.23) Tate, et al (U.S. Pat. No. 5,309,489; 1974) present a nuclear power plant with a cooling system to improve the response of the plant to an accident without using active means. This patent offers redesign of the containment vessel to improve flow of gas within it and thereby improve decay heat removal by air cooling. Although this invention does not specifically address a post-meltdown condition, it could augment the present invention by improving transfer of heat from the containment to the environment.

(1.24) Pop and Lockman (U.S. Pat. No. 8,976,920B2; 2015) present a nuclear power plant with improved cooling system using nano-particles in solid or liquid form for use in the ECCS, using pumps and motor-driven valves and pressurization. The purpose of the system is to prevent a meltdown from occurring and does not address a post, meltdown condition. Furthermore, it uses water as the coolant medium, which offers the disadvantages previously discussed.

(1.25) Schulz (U.S. Pat. No. 5,295,170: 1994) presents a nuclear reactor with a passive means for adjusting the pH of post accident water. In situations in which the core suffers significant damage, radioactive iodine is released in a volatile organic form, which is likely to leak out of the containment vessel. By increasing the pH of the highly acidic water in the containment sump, the iodine can be retained in its particulate form. This system is not in competition with the present invention; however, it does offer an additional means for placing a nuclear power plant suffering a meltdown into a safer configuration.

(1.26) Turricchia (U.S. Pat. No. 5,057,271; 1991) presents a protection system for the basemat of reactor containment buildings which provides for staggered layers of stainless steel beams to intercept molten material escaping from the reactor core during meltdown. Its purpose is to disperse the material within the water pool to promote rapid quenching of the molten material. However, this approach to post meltdown recovery using water as the coolant may experience problems with hydrogen, and also the possibility of supercriticality if the molten mass dispersive system does not function as intended.

### (2) BRIEF SUMMARY OF THE INVENTION

This invention presents s system to minimize damage to personnel and the environment following melt-down of the core of a pressurized water nuclear power plant (PWR) by removing heat from the melted core using solid state carbon dioxide (dry ice) rather than water in order to reduce the risk of inducing criticality in the subcritical assembly which could occur with the addition of water, a moderator, or the risk of an explosion due to the addition of hydrogen produced in the radiolysis of water and in the zirconium-water corrosion reaction; the system uses dry ice pellets manufactured at the site as part of the existing Emergency Core Cooling System (ECCS), or incorporated into the designs of new plants; carbon dioxide also acts as a fire suppressant.

### (3) BRIEF DESCRIPTION OF THE DRAWINGS

FIG. 1. (Prior Art) Schematic of pressurized water nuclear power plant with steam turbine and electrical generator; several loops may exist in large (1000 MWe) plants; Emergency Core Cooling System (ECCS) not shown.

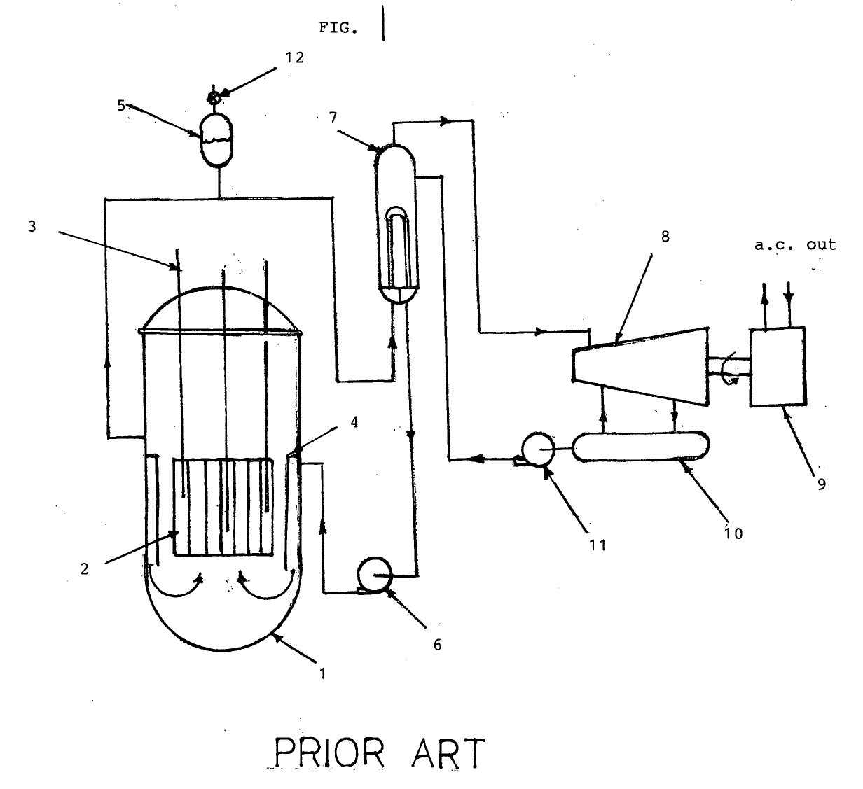

FIG. 2. (Prior Art) Schematic of Emergency Core Coolant System (ECCS) for pressurized water nuclear power plant (PWR); borated water is used in the Emergency Core Coolant System (ECCS).

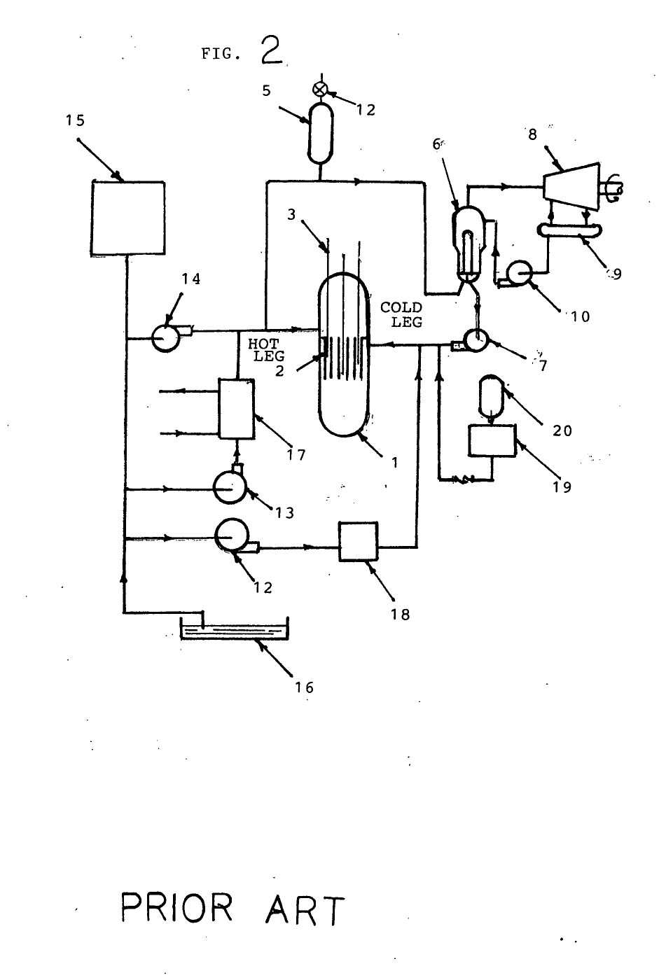

FIG. 3. Schematic of Emergency Core Cooling System for pressurized water nuclear power plant modified for this invention: solid state carbon dioxide (dry ice) pellets replace water in the ECCS.

FIG. 4. Schematic of solid state carbon dioxide (dry ice) nuclear power plant post-meltdown Emergency Core Coolant System (ECCS) created for this invention.

FIG. 5. Schematic of irradiation growth strain as a function of time for Zircaloy tubing; T is temperature.

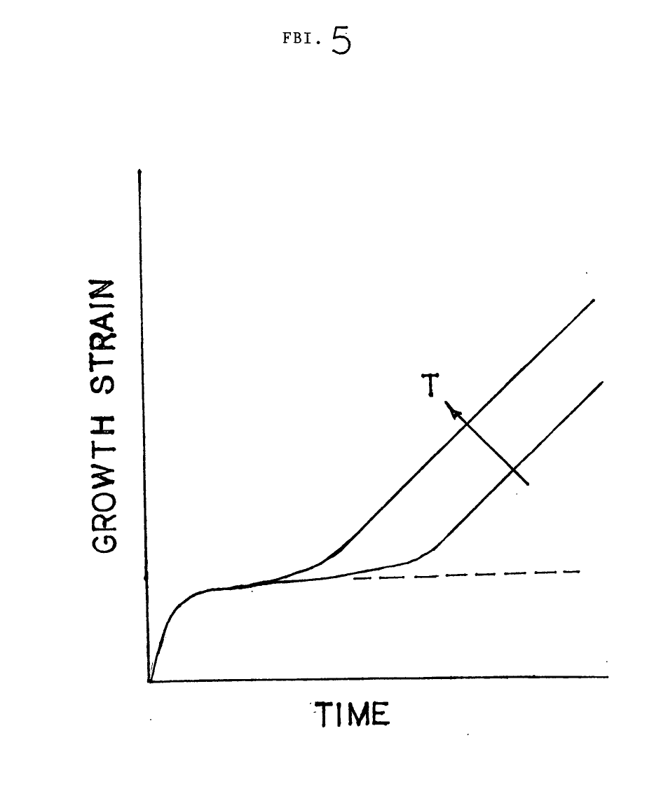

### (4) DETAILED DESCRIPTION OF THE INVENTION

(4.1) If the ECCS previously described fail to perform as intended, such as happened at Three Mile Island, Fukushima and Chernobyl, and meltdown of the core occurs, large amounts of radioactivity may be released to the environment. If the core is subsequently flooded with water to mitigate the situation, such as happened at Fukushima, the possibility of a hydrogen explosion exists, Furthermore, even a supercriticality condition may occur in the melted blob due to the addition of hydrogen, a moderator, if for any reason boron, a neutron absorber, is not included in the water, which could occur by accident, sabotage, or some other cause. Such an event would pose a major risk to a metropolitan area. Somatic and long term genetic effects would be incalculable and property losses extraordinary since, like Chernobyl, a city could become uninhabitable for centuries. Consequently, until nuclear power plants are determined to be no longer necessary, additional protective measures should be provided.

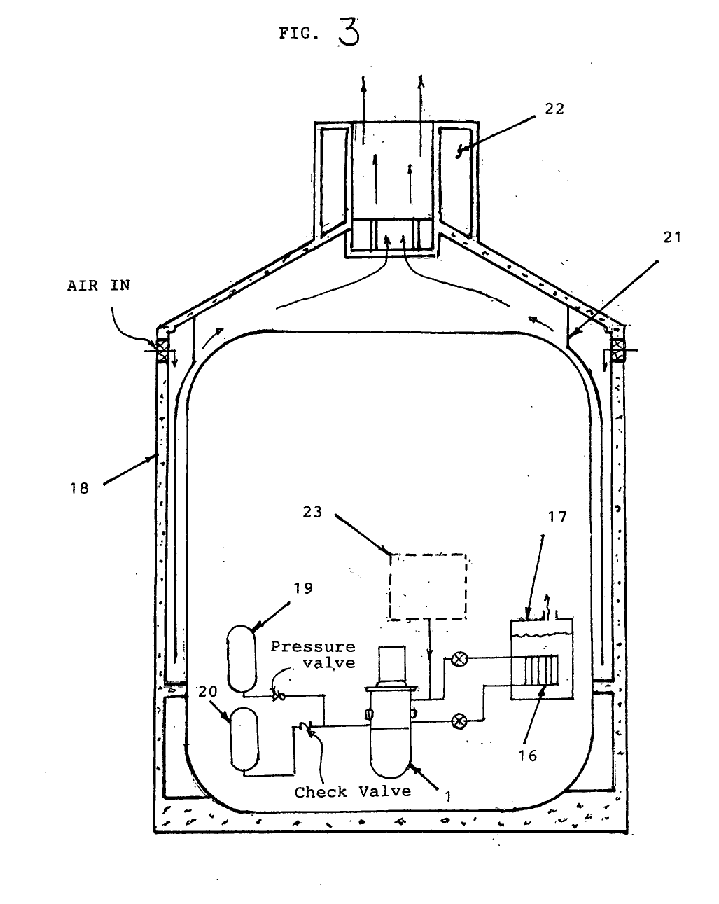

(4.2) In FIG. 3, [23] is the location of the post-meltdown recovery system of this invention. Solid state carbon dioxide (dry ice) pellets are injected into one or more hot legs of the reactor vessel to reach the exposed core region. Dry ice is used in many commercial applications, especially in preserving and processing food, including ice cream vendor vehicles. It leaves no odor, color or other residue and does not pose a toxic danger for post-event cleanup. Additionally, carbon is not an effective moderator for neutrons in the fission reaction, consequently dry ice poses a much less risk than water for inducing a supercriticality event in the damaged core, and the absence of hydrogen produced in the radiolysis of water or in the zirconium-water corrosion reaction reduces the likelihood of a hydrogen explosion.

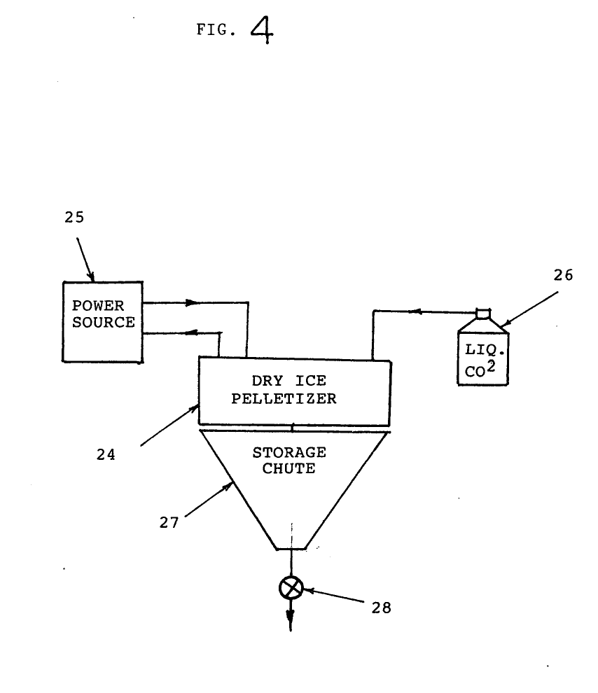

(4.3) Dry ice, traditionally produced in blocks, is now produced in pellets for easier handling. In FIG. 4, the power source for a dry ice pelletizer [25] may include a self-powered electrical generator, battery, or external source, if available. Liquid carbon dioxide is provided in a cryogenic container [26]. An insulated chute [27] retains the pellets until needed. A transparent viewing window may be used to determine the level of pellets in the chute, or some other means. Unlike water, which agglomerates upon melting, dry ice pellets remain separated during sublimation. A remotely controlled valve [28] controls release of the pellets into the reactor vessel hot leg.

(4.4) Once the dry ice pellets sublimate, gaseous carbon dioxide acts as a fire suppressant, an additional safety feature. A dry ice container (Benedetti and Buil: U.S. Pat. No. 6,209,341 B1; 2001) may be used for the chute.

(4.5) The relative merits of dry ice versus water in removing heat is reflected in the amount of heat required to turn one gram of ice at −10° C. to steam at 100° C., 0.73 cal, versus that required to sublimate one gram of dry ice at −79° C., 136 cal, at atmospheric pressure.

(4.6) To estimate the mass and volume of dry ice required, consider a 3800 MW(th) reactor described in Table 13.2 of Reference 6. The fuel mass (UO2) is 116E3 KG. Given the number of Zircaloy rods, their dimensions and the density of Zircaloy, a reasonable estimate for the mass of cladding is 2.7E4 KG. Heat in the fuel is about 2.6E19 cal; that in the clad is about 0.8E10 cal at full power. From Table 2.13 of Ref. 6, if the core has been operating for a long time, the residual power following shutdown (decay heat) is 0.013 P_{O} and 4.9E-3 P_{O} after 1 hr and 1 day, respectively, where P_{O} is the initial power. Using 0.013 as power ratio, the total heat in the core is estimated to be 4.4E8 cal. The mass of dry ice required to be sublimated by this heat is 3200 KG. Assuming the density of dry ice is 1.12 gm/cc, the volume of dry ice required is about 2.9M3.

(4.7) Dry ice in pellets will occupy more space than solid dry ice. The packing fraction for spheres is about 0.75, increasing the space needed to about 3.8M3. A chute of height 1.9 M with 2×2 M opening will accommodate this volume. However, the shape of the chute can be adjusted to fit the space available and an additional 10% or so is advisable for the volume for clearance. The pellets may be of any size to accommodate a commercial pelletizer (e.g several millimeters diameter.)

I claim:

1. A system to remove heat from the core of a pressurized water reactor (PWR) nuclear power plant following a core meltdown using solid state carbon dioxide (dry ice) as the cooling medium;

2. The system according to claim 1 comprising a dry ice pelletizer, self-contained power supply, liquid carbon dioxide container, storage chute, and a valve controlling flow of dry ice pellets into one or more hot legs of the reactor vessel;

3. That the system according to claims 1 and 2 reduces the risk of a post-meltdown hydrogen explosion due to radiolysis of water or a zirconium-hydrogen corrosion reaction, or of initiating a supercriticality condition upon introducing hydrogen, a moderator, to the melted subcritical assembly, upon activation of Emergency Core Cooling Systems (ECCS) which use water as the coolant, prevalent in existing and planned PWRs.
